(19) United States
(12) Patent Application Publication
(10) Pub. No.: US 2014/0195212 A1
(43) Pub. Date: Jul. 10, 2014

(54) MOTION ANALYSIS APPARATUS AND MOTION ANALYSIS METHOD

(71) Applicant: FUJITSU LIMITED, Kawasaki-shi (JP)

(72) Inventors: Keita OGASAWARA, Kawasaki (JP); Masaki KAZAMA, Kawasaki (JP)

(73) Assignee: FUJITSU LIMITED, Kawasaki-shi (JP)

(21) Appl. No.: 14/203,701

(22) Filed: Mar. 11, 2014

Related U.S. Application Data
(63) Continuation of application No. PCT/JP2011/070764, filed on Sep. 12, 2011.

(51) Int. Cl. G06F 17/50

(52) U.S. Cl. CPC G06F 17/5009
USPC 703/2

(57) ABSTRACT

A motion analysis apparatus includes a storage section configured to store data representing a plurality of particles representing an object; a partitioning process section configured to partition a particle of interest among the plurality of particles and to store data representing a plurality of partitioned particles obtained by partitioning the particle of interest into the storage section if a predetermined uneven distribution relationship exists between the particle of interest and other particles existing within a predetermined range having the particle of interest at a center of the predetermined range; and a motion analysis section configured to analyze the motion of the object depending on a type of the object using the data representing the plurality of partitioned particles stored in the memory storage section.

### CROSS-REFERENCE TO RELATED APPLICATIONS

This application is a continuation application of International Application PCT/JP2011/070764 filed on Sep. 12, 2011 and designated the U.S., the entire contents of which are incorporated herein by reference.

### FIELD

The disclosures herein generally relate to a motion analysis apparatus and a motion analysis method.

### BACKGROUND

Conventionally, apparatuses for computer simulation have been widely used in various fields that reproduce motion of objects on a computer and output simulation results. As a technology related to the above, a method called a “particle method” has been known that is used for analyzing motion of an object that is recognized as a collection of particles, and motion of each of the particles is analyzed.

As representative particle methods, an SPH (Smoothed Particle Hydrodynamics) method and an MPS (Moving Particle Semi-implicit) method are known (see, for example, Non-Patent Documents 1-2). In these methods, particles that exist within a distance h, called an “influential radius”, from a certain particle are handled as neighboring particles. The methods analyze motion of particles assuming that repulsive force operates between particles within the influential radius h.

The next formula (1) is an example of a formula in an SPH method that discretizes the equation of motion where subscripts a and b are identifiers for distinguishing particles; and #rₐ, #vₐ, ρₐ, Pₐ, mₐ, and Π_{ab} represent a position vector, a velocity vector, density, pressure, mass, and a viscous stress tensor of a particle “a”, respectively. Note that “#” indicates that the following alphabetical identifier represents a vector.

$$\frac{d {v}_{a}}{d t} = - {\sum }_{b} {m}_{b} [ ( \frac{{P}_{b} + {P}_{a}}{{ρ}_{b} {ρ}_{a}} ) + {\prod }_{ab} ] \frac{\partial W ( \vert {r}_{a} - {r}_{b} \vert , h )}{\partial {r}_{a}} \qquad ( 1 )$$

W is a kernel function in the above formula (1). The kernel function W is used for configuring a continuous field from particle distribution. As a specific kernel function W, for example, a cubic spline function may be used that is represented by the next formula (2). In the formula, h represents an influential radius between particles that is often set two to three times greater than an average particle interval in an initial state. β is a value that is adjusted to make an integral of the kernel function over the entire space amount to one, which is determined 0.7 πh² for 2D and πh³ for 3D.

$$W ( r , h ) = \{ \begin{matrix}( 1 - 1.5 {( \frac{r}{h} )}^{2} + 0.75 {( \frac{r}{h} )}^{3} ) / β & 0 \leq \frac{r}{h} < 1 \\ 0.25 {( 2 - \frac{r}{h} )}^{3} / β & 1 \leq \frac{r}{h} < 2 \\ 0 & 2 \leq \frac{r}{h}\end{matrix} \qquad ( 2 )$$

Alternatively, for cases where viscosity of a fluid can be neglected to be treated as a perfect fluid, the terms for the viscous stress tensor Π_{ab} in the above formula (1) can be neglected, which results in a simplified formula (3) below.

$$\frac{d {v}_{a}}{d t} = - {\sum }_{b} {m}_{b} ( \frac{{P}_{a} + {P}_{b}}{{ρ}_{a} {ρ}_{b}} ) \frac{\partial W ( \vert {r}_{a} - {r}_{b} \vert , h )}{\partial {r}_{a}} \qquad ( 3 )$$

An invention is disclosed that is about a method and the like for flow analysis using a particle method (see, for example, Patent Document 1). In this method, multiple computers handle particles having particle diameters specified for the respective computers. Each of the computers partitions a particle in an analysis region allocated to the computer into multiple particles if the particle has a particle diameter exceeding an upper limit value.

### RELATED-ART DOCUMENTS

### Patent Documents

[Patent Document 1] Japanese Laid-open Patent Publication No. 2007-140993

### Non-Patent Document

[Non-Patent Document 1] J. J. Monaghan, “Smoothed Particle Hydrodynamics”, Annu. Rev. Astron. Astrophys. 30: 543-74 (1992)
[Non-Patent Document 2] S. Koshizuka, A. Nobe and Y. Oka, “Numerical Analysis of Breaking Waves Using The Moving Particle Semi-Implicit Method”, International Journal for Numerical Method in Fluids, 26:751-769 (1998)

Incidentally, when using a particle method for analyzing motion of a fluid or an elastic body, a part where particles are sparse may partially appear if the fluid or elastic body is deformed significantly by shredding, shearing, and the like, and particles constituting the object are moved. As a result, a particle may not have a sufficient number of other particles around it to correctly calculate a force that operates on the particle (repulsive force and/or shearing force), which may make a result of motion analysis dissociated with reality.

### SUMMARY

According to at least one embodiment of the present invention, a motion analysis apparatus includes a storage section configured to store data representing a plurality of particles representing an object; a partitioning process section configured to partition a particle of interest among the plurality of particles and to store data representing a plurality of partitioned particles obtained by partitioning the particle of interest into the storage section if a predetermined uneven distribution relationship exists between the particle of interest and other particles existing within a predetermined range having the particle of interest at a center of the predetermined range; and a motion analysis section configured to analyze the motion of the object depending on a type of the object using the data representing the plurality of partitioned particles stored in the memory storage section.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of a hardware configuration of a motion analysis apparatus 1 according to a first embodiment of the present invention;

FIG. 2 is a schematic view illustrating an example of a functional configuration of the motion analysis apparatus 1 according to an embodiment of the present invention;

FIG. 3 is a schematic view illustrating a state where the number of other particles “b” that exist around a particle “a” is less than a predetermined number;

FIG. 4 is a schematic view illustrating a state where a particle “a” and other particles “b” exist on substantially the same plane;

FIG. 5 is a schematic view illustrating a state where a particle “a” and other particles “b” exist on substantially the same line;

FIG. 6 is a schematic view illustrating an example of a positional relationship between a particle “a” and particles “b” that are defined as existing on substantially the same plane;

FIG. 7 is a schematic view illustrating an example of a positional relationship between a particle “a” and particles “b” that are defined as existing on substantially the same plane;

FIG. 8 is a schematic view illustrating an example of a positional relationship between a particle “a” and particles “b” that are defined as existing on substantially the same line;

FIG. 9 is a schematic view illustrating an example of a positional relationship between a particle “a” and particles “b” that are defined as existing on substantially the same line;

FIG. 10 is a schematic view illustrating that a particle “a” is partitioned into six particles a_{—}1-a_{—}6;

FIG. 11 is a schematic view illustrating that a particle “a” is partitioned into two particles a_{—}1-a_{—}2;

FIG. 12 is a schematic view illustrating that a particle “a” is partitioned into four particles a_{—}1-a_{—}4;

FIG. 13 is a schematic view conceptually illustrating density ρ* represented by a kernel function W;

FIG. 14 is a flowchart illustrating a flow of an overall process executed by a motion analysis apparatus 1;

FIG. 15 is a flowchart illustrating a flow for determining whether a partitioning process is required; and

FIG. 16 is a flowchart illustrating a flow of a partitioning process;

### DESCRIPTION OF EMBODIMENTS

In the following, embodiments of the present invention will be described with reference to the accompanying drawings.

Note that vector representation is adopted in the drawings and formulas in principle, whereas a vector in the text is denoted by a leading “#” followed by an alphabetical identifier.

### Embodiments

In the following, a motion analysis apparatus 1, a motion analysis method, and a motion analysis program will be described according to an embodiment of the present invention. The motion analysis apparatus 1 is an apparatus for analyzing motion of an object such as a fluid, an elastic body, a rigid body, or the like in a virtual 3D space or 2D plane, based on a particle method.

[Hardware Configuration]

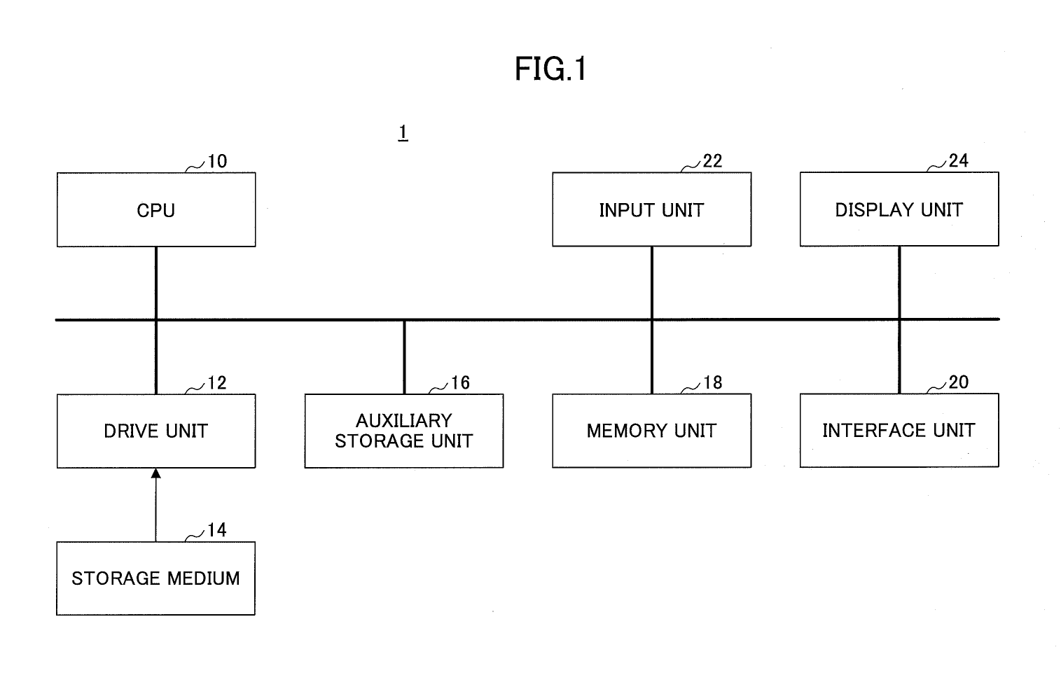

FIG. 1 illustrates an example of a hardware configuration of the motion analysis apparatus 1 according to a first embodiment of the present invention. The motion analysis apparatus 1 is an information processing apparatus that includes, for example, a CPU (Central Processing Unit) 10, a drive unit 12, an auxiliary storage unit 16, a memory unit 18, an interface unit 20, an input unit 22, and a display unit 24. These configuration elements are connected with each other via a bus, a serial communication channel, or the like.

The CPU 10 is a calculation processing unit such as a processor or the like that includes, for example, a program counter, an instruction decoder, various arithmetic units, an LSU (Load/Store Unit), general-purpose registers, and the like.

The drive unit 12 is a unit that can read a program or data from a recording medium 14. When the recording medium 14 storing a program is mounted on the drive unit 12, the program is installed from the recording medium 14 to the auxiliary storage unit 16 via the drive unit 12. The recording medium 14 is a portable recording medium, for example, a CD-ROM, a DVD disk, a USB memory, or the like. Also, the auxiliary storage unit 16 is, for example, an HDD (Hard Disk Drive) or a flash memory.

Installation of a program can be executed not only by the recording medium 14 as above, but also by the interface unit 20 that downloads a program from another computer via a network and installs the program in the auxiliary storage unit 16. The network may be the Internet, a LAN (Local Area Network), a wireless network, or the like. Also, a program may be stored beforehand in the auxiliary storage unit 16, a ROM (Read-Only Memory), or the like at shipment of the information processing apparatus.

By having the CPU 10 execute the program having been installed or stored beforehand as above, the information processing apparatus as illustrated in FIG. 1 can function as the motion analysis apparatus 1 according to the present embodiment.

The memory unit 18 includes, for example, a RAM (Random Access Memory) and an EEPROM (Electrically Erasable and Programmable Read-Only Memory). The interface unit 20 controls connection and the like with the network.

The input unit 22 includes, for example, a keyboard, a mouse, a touch pad, a touch panel, a microphone, and the like. Also, the display unit 24 is a display device, for example, an LCD (Liquid Crystal Display), a CRT (Cathode Ray Tube), or the like. The motion analysis apparatus 1 may include other types of output units besides the display unit 24, such as a printer and a loudspeaker.

[Functional Configuration]

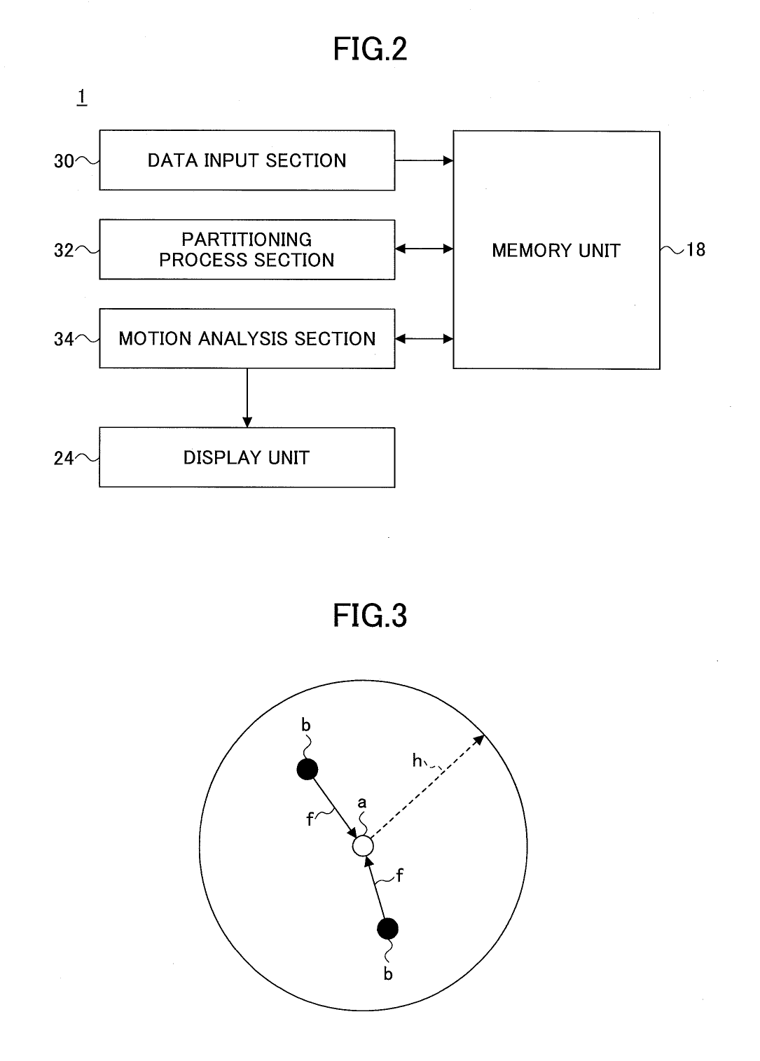

FIG. 2 illustrates an example of a functional configuration of the motion analysis apparatus 1 according to an embodiment of the present invention. The motion analysis apparatus 1 includes a data input section 30, a partitioning process section 32, and a motion analysis section 34. These functional blocks function as the CPU 10 executes program software stored in the auxiliary storage unit 16 or the like. Note that these functional blocks do not necessarily need to be implemented as explicitly separated programs, but they may be subroutines and/or functions called by other programs. Also, a part of a functional block may be implemented by hardware such as an IC (Integrated Circuit), an FPGA (Field Programmable Gate Array), or the like.

[Data Input]

The data input section 30 receives data of particles that constitute an object as input, and stores the data into the memory unit 18. The input data is data of a set of particles that models a fluid, an elastic body or the like, and specifically includes, center coordinate values, velocity, an influential radius, density, mass, a deformation gradient tensor, physical properties of the material, temperature, and the like of each particle.

The data may be stored in the auxiliary storage unit 16 beforehand, or may be input by a user using the input unit 22. Alternatively, the data may be installed from the recording medium 14 to the auxiliary storage unit 16, or may be obtained from the network by the interface unit 20.

Note that a deformation gradient tensor Fᵢⱼ is represented by the next formula (4) in general where Xⱼ represents j component of a distance between positions of particles, uᵢ represents i component of a displacement of a particle, and I represents an identity tensor. The i component and j component correspond to three components of x, y, and z that represent 3D coordinate values if a 3D space is assumed.

$${F}_{ij} = \frac{\partial {u}_{i}}{\partial {X}_{j}} + I \qquad ( 4 )$$

A deformation gradient tensor of a particle “a” in a particle method is represented by, for example, the next formula (5) in which influences of particles “b” are superposed that exist within a region having the particle “a” at the center and the influential radius of the particle “a” as the radius. In the formula, du represents a displacement of the particle “a”. In the following, “exist within a region that has a particle “a” at the center and the influential radius of the particle “a” as the radius” is simply expressed as “exist in the perimeter of a particle “a”.

$${F}_{ij}^{a} = - {\sum }_{i} \frac{{m}^{b}}{{ρ}^{b}} ( d {u}_{i}^{a} - d {u}_{i}^{b} ) \frac{\partial W}{\partial {x}_{j}^{b}} + I \qquad ( 5 )$$

Note that the data input section 30 may have a function for setting up data represented by particles from data of an object in a case where the input data is not represented by particles.

The partitioning process section 32 determines whether to partition a particle by taking the position and influential radius of each particle into consideration, which are stored in the memory unit 18, and executes a partitioning process.

[Determination of Partitioning]

The partitioning process of a particle is executed in a state where a repulsive force does not correctly operate that is supposed to be received by the particle “a” from particles that exist the perimeter of the particle “a”.

In such a state, a predetermined uneven distribution relationship exists between the particle “a” and the other particles “b”. A “predetermined uneven distribution relationship” means that, for example: (A) a state where the number of the other particles “b” that exist in the perimeter of the particle “a” is less than a predetermined number (for example, about three in 3D, and about two for 2D), or; (B) a relationship between the particle “a” and all the other particles “b” existing in the perimeter of the particle “a” where they all exist on substantially the same plane or substantially the same line.

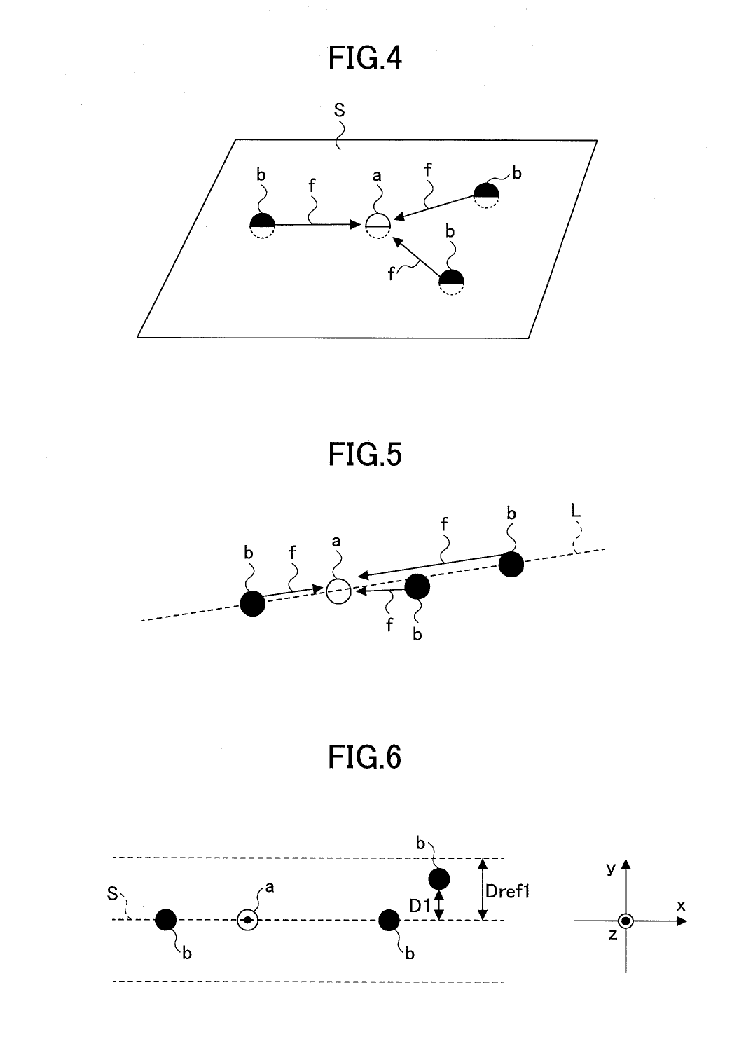

FIG. 3 illustrates a state of the above (A) (two particles “b”) and FIGS. 4-5 illustrate states of the above (B). In FIG. 3, f represents a repulsive force that the particle “a” receives from each of the particles “b”. Also, S denotes a plane in FIG. 4 and L denotes a line in FIG. 5. Note that if a space handled by the motion analysis apparatus 1 is 2D, a state where a particle “a” and other particles “b” exist on substantially the same plane is excluded from “predetermined uneven distribution relationships”.

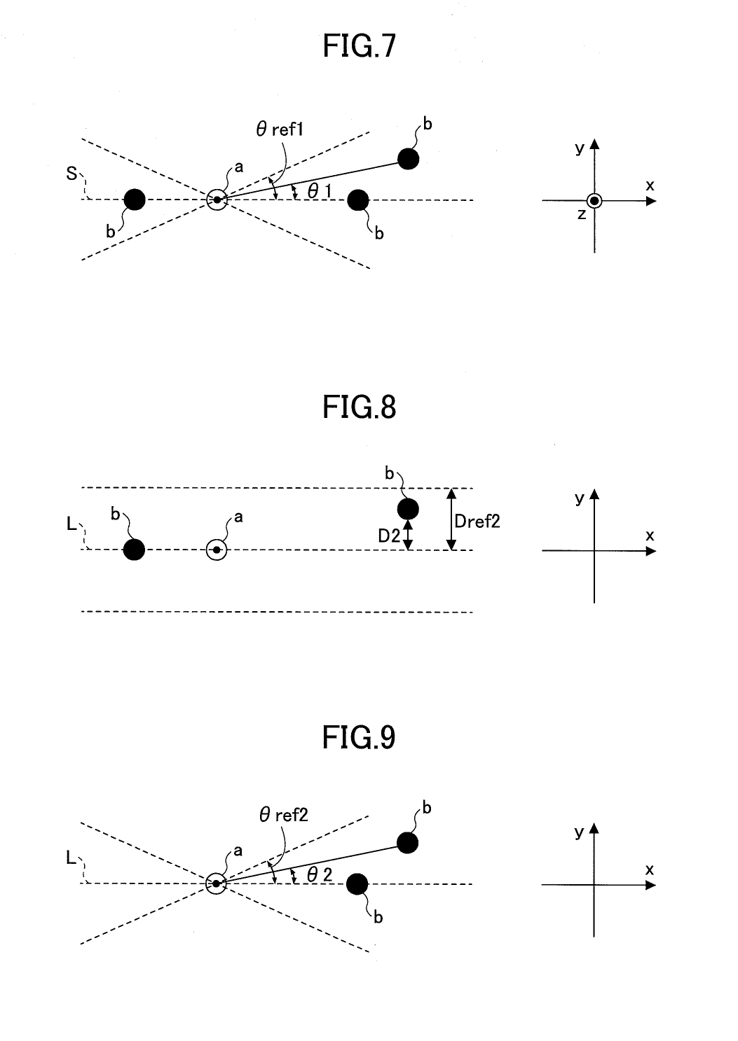

Note that “exist on substantially the same plane” may be defined as, for example, “(every particle b) has a distance D1 within a predetermined value Dref1 from a reference plane S which is defined to include a particle “a” and two arbitrary particles “b” existing in the peripheral of the particle “a”. Alternatively, “exist on substantially the same plane” may be defined in terms other than the above, such as “every vector from a particle “a” to a particle b has an angle θ1 within a predetermined angle θref1 relative to the reference plane S”. FIGS. 6-7 are schematic view illustrating examples of a positional relationship between a particle “a” and particles “b” that are defined as existing on substantially the same plane.

Also, “exist on substantially the same line” may be defined as, for example, “(every particle b) has a distance D2 within a predetermined value Dref2 from a reference line L which is defined to include a particle “a” and an arbitrary particle b existing in the peripheral of the particle “a”. Alternatively, “exist on substantially the same line” may be defined in terms other than the above, such as “every vector from a particle “a” to a particle b has an angle θ2 within a predetermined angle θref2 relative to the reference line L”. FIGS. 8-9 are schematic views illustrating examples of a positional relationship between a particle “a” and particles “b” that are defined as existing on substantially the same line.

In a state of the above (A), a particle can move comparatively freely because it does not receive sufficient repulsive forces from particles “b” in the perimeter. Also, in a state of the above (B), a particle “a” can move comparatively freely in a direction perpendicular to a reference plane S or a reference line L. Either of the states is not appropriate as a model for realistic behavior of particles that constitute a fluid or an elastic body. Therefore, if a particle “a” falls into a state of the above state (A) or (B), the partitioning process section 32 partitions the particle “a” into multiple particles, and stores data of positions, mass, and the like of newly partitioned particles into the memory unit 18.

The partitioning process section 32 calculates a re-normalization matrix L(#r) represented by, for example, the next formula (6), obtains a determinant det L(#r), and determines whether to partition the particle by comparing the determinant det L(#r) with a threshold value Ref. Specifically, the partitioning process section 32 determines that partitioning the particle is required if the determinant det L(#r) exceeds the threshold value Ref, or partitioning the particle is not required if the determinant det L(#r) is less than or equal to the threshold value Ref. Note that the next formula (6) represents a re-normalization matrix L(#r) for a 3D space handled by the motion analysis apparatus 1. #r is a position vector of a particle “a” that has components (x, y, z).

$$L ( r ) = {( \begin{matrix}{\sum }_{b} ( {x}_{b} - x ) \frac{\partial }{\partial x} W ( \vert r - {r}_{b} \vert , h ) & {\sum }_{b} ( {x}_{b} - x ) \frac{\partial }{\partial y} W ( \vert r - {r}_{b} \vert , h ) & {\sum }_{b} ( {x}_{b} - x ) \frac{\partial }{\partial z} W ( \vert r - {r}_{b} \vert , h ) \\ {\sum }_{b} ( {y}_{b} - y ) \frac{\partial }{\partial x} W ( \vert r - {r}_{b} \vert , h ) & {\sum }_{b} ( {y}_{b} - y ) \frac{\partial }{\partial y} W ( \vert r - {r}_{b} \vert , h ) & {\sum }_{b} ( {y}_{b} - y ) \frac{\partial }{\partial z} W ( \vert r - {r}_{b} \vert , h ) \\ {\sum }_{b} ( {z}_{b} - z ) \frac{\partial }{\partial x} W ( \vert r - {r}_{b} \vert , h ) & {\sum }_{b} ( {z}_{b} - z ) \frac{\partial }{\partial y} W ( \vert r - {r}_{b} \vert , h ) & {\sum }_{b} ( {z}_{b} - z ) \frac{\partial }{\partial z} W ( \vert r - {r}_{b} \vert , h )\end{matrix} )}^{- 1} \qquad ( 6 )$$

If a space handled by the motion analysis apparatus 1 is 2D, the re-normalization matrix L is a 2×2 matrix that is represented by the next formula (7). In this case, #r has components (x, y).

$$L ( r ) = {( \begin{matrix}{\sum }_{b} ( {x}_{b} - x ) \frac{\partial }{\partial x} W ( \vert r - {r}_{b} \vert , h ) & {\sum }_{b} ( {x}_{b} - x ) \frac{\partial }{\partial y} W ( \vert r - {r}_{b} \vert , h ) \\ {\sum }_{b} ( {y}_{b} - y ) \frac{\partial }{\partial x} W ( \vert r - {r}_{b} \vert , h ) & {\sum }_{b} ( {y}_{b} - y ) \frac{\partial }{\partial y} W ( \vert r - {r}_{b} \vert , h )\end{matrix} )}^{- 1} \qquad ( 7 )$$

With either of the above formulas (6)-(7), if particles “b” that exist in the perimeter of a particle “a” are evenly distributed, det L(#r) takes a value close to 1.

On the other hand, in a state of the above (A) or (B), det L(#r) increases and takes a value up to infinity. Therefore, the partitioning process section 32 executes a partitioning process of the particle “a” if the determinant det L(#r) is greater than or equal to the threshold value Ref. Based on the above property of the determinant det L(#r), the threshold value Ref is set within an arbitrary range that exceeds 1 but not 2.

Note that, the threshold value Ref is a parameter that determines a degree of “substantiality” as in “substantially the same plane” or “substantially the same line”. The greater the threshold value is set, the less likely a partitioning process is executed, and the narrower a range is covered by “substantially the same plane” and “substantially the same line”. On the other hand, the less the threshold value is set, the more likely a partitioning process is executed, and the wider a range is covered by “substantially the same plane” and “substantially the same line”.

[Partitioning Process]

Determining that a partitioning process of a particle “a” needs to be executed by the above method, the partitioning process section 32 executes the partitioning process of the particle “a” by the following steps.

First, the number of partitions of the particle “a”, represented as i, is determined. Although the number i may be determined discretionally, it is preferable to set up predetermined rules for partitioning that depend on a state, as follows.

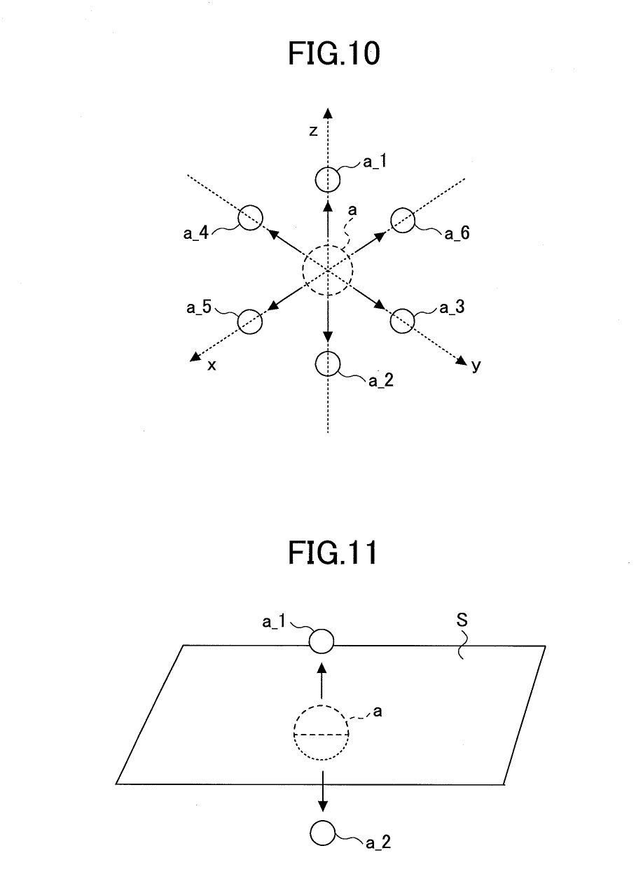

If the number of other particles “b” that exist in the perimeter of the particle “a” is less than a predetermined number, for example, the particle “a” is partitioned, for example, in the x axis direction, y axis direction, and z axis direction, respectively, to obtain six new particles. FIG. 10 is a schematic view illustrating that a particle “a” is partitioned into six particles a_{—}1-a_{—}6.

Also, if a particle “a” and all other particles “b” that exist in the perimeter of the particle “a” exist on substantially the same plane, for example, the particle “a” is partitioned into, for example, two new particles in a direction perpendicular to a reference plane S described above. FIG. 11 is a schematic view illustrating that a particle “a” is partitioned into two particles a_{—}1-a_{—}2.

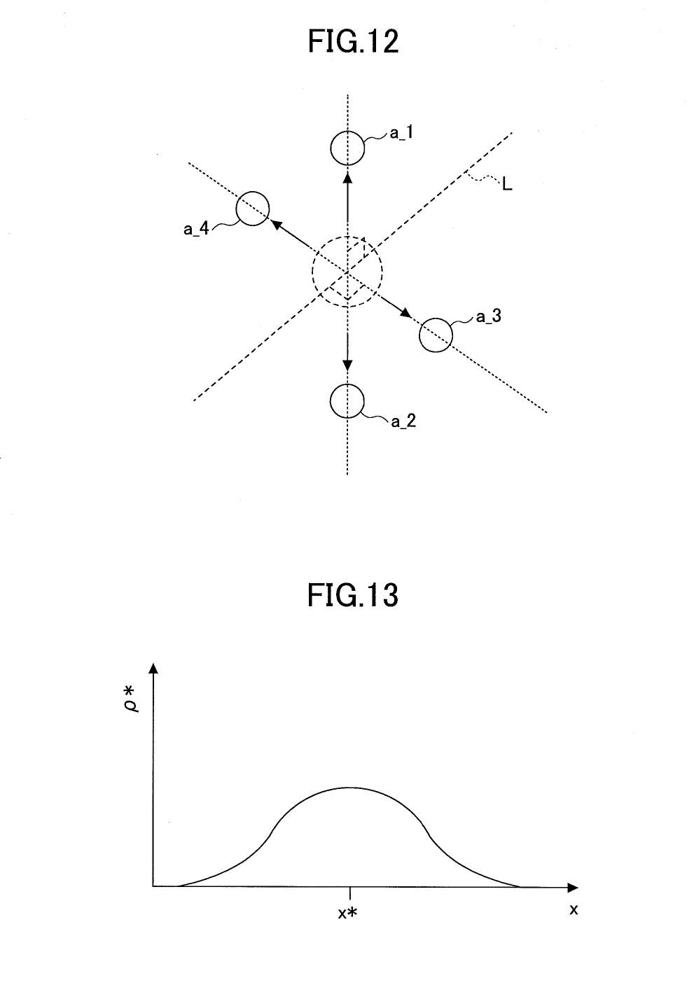

Also, if a particle “a” and all other particles “b” that exist in the perimeter of the particle “a” exist on substantially the same line, for example, the particle “a” is partitioned into, for example, four new particles in two directions perpendicular to a reference line L described above. FIG. 12 is a schematic view illustrating that a particle “a” is partitioned into four particles a_{—}1-a_{—}4.

Thus, if a particle “a” and particles “b” that exist in the perimeter of the particle “a” have an uneven distribution relationship, namely, a relationship where they exist on substantially the same plane or substantially the same line, it is preferable to partition the particle “a” in a direction perpendicular to a plane or a line that is parallel to the uneven distribution direction.

The partitioning process section 32 determines distances between partitioned particles and influential ranges of the partitioned particles as follows. Assuming that the position of a particle before partitioning is #x*, the partitioning process section 32 determines the positions #xⁱ (i=1, 2, . . . ) of partitioned particles following the rules for partitioning mentioned before in a region where the distance from the particle is less than or equal to the influential radius. As the influential radius of a partitioned particle, the same value as the influential radius of the particle before partitioning may be used.

Note that a partitioning process of particles may not partition each particle independently, but may partition two particles into three particles.

Note that, considering analytical properties of a particle method, it is preferable to make density distribution of a group of partitioned particles close to density distribution of a particle before partitioning as much as possible. Density ρ* of a particle at #x* before partitioning is represented by the next formula (8) where M represents the mass of the particle #x* before partitioning and W is a kernel function described earlier. FIG. 13 is a schematic view conceptually illustrating density ρ* represented by the kernel function W.

ρ*=MW(x−x*) (8)

On the other hand, density ρ of the group of partitioned particles is represented by the next formula (9) using a superposition formula of a particle method where mᵢ (i=1, 2, . . . ) is mass of each of the partitioned particles that needs to satisfy a constraint condition, M=Σᵢmᵢ.

$$ρ = {\sum }_{i} {m}_{i} W ( x - {x}^{i} ) \qquad ( 9 )$$

The partitioning process section 32 uses the method of Lagrange multipliers for obtaining an optimum solution of the mass mi that makes the density ρ close to the density ρ* under the constraint condition above. First, the partitioning process section 32 defines energy J(mi) represented by the next formula (10).

$$J ( {m}_{i} ) = \int {( M W ( x - {x}^{*} ) - {\sum }_{i} {m}_{i} W ( x - {x}_{i} ) )}^{2} d x - λ ( M - {\sum }_{i} {m}_{i} ) \qquad ( 10 )$$

Next, the partitioning process section 32 takes a solution mᵢ of the next formula (11), with which the defined energy J(mᵢ) takes an extreme value, as an optimum mass of each of the partitioned particles. Specifically, the partitioning process section 32 formulates linear simultaneous equations on mᵢ and λ from the next formula (11) as the formula (11) is satisfied with arbitrary δmᵢ and δλ, and the above formula (10) is a quadratic or lower-dimensional formula with respect to mᵢ and λ. Then, the partitioning process section 32 solves the linear simultaneous equations to obtain an optimum value that minimizes an error difference between the density represented by the particle before partitioning and the density of the group of partitioned particles.

$${\sum }_{i = 1}^{N} \frac{\partial J}{\partial {m}_{i}} \partial {m}_{i} + \frac{\partial J}{\partial λ} \partial λ = 0 \qquad ( 11 )$$

The method described above first determines the position of the group of partitioned particles, then obtains the optimum mass of each of the partitioned particles. Alternatively, the mass of each of the partitioned particles may be determined first, then the optimum position of each of the partitioned particles may be obtained.

In this case, the partitioning process section 32 sets up a constraint condition represented by, for example, the next formula (12) that states the total value of displacements of the positions of the particles from those before partitioning is 0.

$${\sum }_{i} ( {x}^{*} - {x}^{i} ) = 0 \qquad ( 12 )$$

Further, the partitioning process section 32 defines energy J(#xi) represented by the next formula (13).

$$J ( {x}_{i} ) = \int {( M W ( x - {x}^{*} ) - {\sum }_{i} {m}_{i} W ( x - {x}_{i} ) )}^{2} d x - λ ( {\sum }_{i} ( {x}^{*} - {x}^{i} ) ) \qquad ( 13 )$$

Then, the partitioning process section 32 sets a solution #xᵢ of the next formula (14), with which the defined energy J(#xᵢ) takes an extreme value, as an optimum position for each of the partitioned particles. Specifically, the partitioning process section 32 formulates linear simultaneous equations on #xᵢ and λ from the next formula (14) as the formula (14) is satisfied with arbitrary δxᵢ and δλ, and the above formula (13) is a quadratic or lower-dimensional formula with respect to #xᵢ and λ. Then, the partitioning process section 32 solves the linear simultaneous equations to obtain an optimum value that minimizes an error difference between the density represented by the particle before partitioning and the density of the group of partitioned particles.

$${\sum }_{i = 1}^{N} \frac{\partial J}{\partial {x}_{i}} \partial {x}_{i} + \frac{\partial J}{\partial λ} \partial λ = 0 \qquad ( 14 )$$

Note that although the methods are described as examples where the one determines the position, and then obtains the optimum mass; and the other determines the mass, and then obtains the optimum position. Any other methods may be used for partitioning as long as they keep the mass before and after partitioning unchanged and makes a change of the density or the like small before and after partitioning.

[Motion Analysis]

The motion analysis section 34 analyzes motion of an object constituted with particles by applying a physical model that is predetermined for a type of the object that may be a fluid, an elastic body, a rigid body, or the like. In the following, an example of a physical model will be described that is used by the motion analysis section 34.

For example, if an object is a fluid, the motion analysis section 34 uses equations of motion for an incompressible fluid (the next formulas (15)-(17)) and an equation of motion that is obtained by discretizing the Navier-Stokes equation (the above formula (1)), to obtain time differentials of acceleration and temperature. In the formulas, u represents internal energy, Π represents a viscous stress tensor, κ represents a heat conduction coefficient, and T represents temperature.

$$\begin{matrix}\frac{D ρ}{D t} = - ρ ∇ \cdot v & ( 15 ) \\ \frac{D v}{D t} = - \frac{1}{ρ} ∇ p + ∇ \cdot Π & ( 16 ) \\ \frac{D u}{D t} = - \frac{p}{ρ} ∇ \cdot v + {Π}_{ij} \frac{\partial {v}_{j}}{\partial {x}_{i}} + κ {∇}^{2} T & ( 17 )\end{matrix}$$

If an object is an elastic body, the motion analysis section 34 solves the next formulas (18)-(20) with a deformation gradient tensor obtained with the above formula (4) to calculate Cauchy stress σ. In the formulas, C represents a Cauchy-Green deformation tensor, E represents a Green-Lagrange strain tensor, j represents a volume change rate, and Q represents elastic potential.

$$\begin{matrix}C = {F}^{- j} \cdot F & ( 18 ) \\ E = \frac{1}{2} ( C - 1 ) & ( 19 ) \\ σ = \frac{1}{j} ( F \cdot \frac{\partial Q}{\partial {E}_{ij}} \cdot {F}^{T} ) & ( 20 )\end{matrix}$$

As the elastic potential Q above, the motion analysis section 34 uses potential of a linear spring represented by the next formula (21) or Mooney-Rivlin potential represented by the next formulas (22)-(24). In the formula, k represents a spring constant, and tr represents a trace of a matrix.

$$\begin{matrix}Q = \frac{1}{2} k {x}^{2} & ( 21 ) \\ Q = {c}_{1} ( {I}_{c} - 3 ) + {c}_{2} ( {II}_{c} - 3 ) & ( 22 ) \\ {I}_{c} = tr C & ( 23 ) \\ {II}_{C} = \frac{1}{2} \{ {[ tr C )}^{2} - tr ( {C}^{2} ) \} & ( 24 )\end{matrix}$$

Having calculated Cauchy stress σ as the stress tensor, the motion analysis section 34 obtains an equation of motion with the next formula (25).

$$\frac{Dv}{Dt} = - \frac{1}{ρ} ∇ \cdot σ \qquad ( 25 )$$

Note that, in addition to the physical models corresponding to the types of objects, the motion analysis section 34 may use widely known Newton's equation of motion and the like to analyze motion of an object.

[Process Flow]

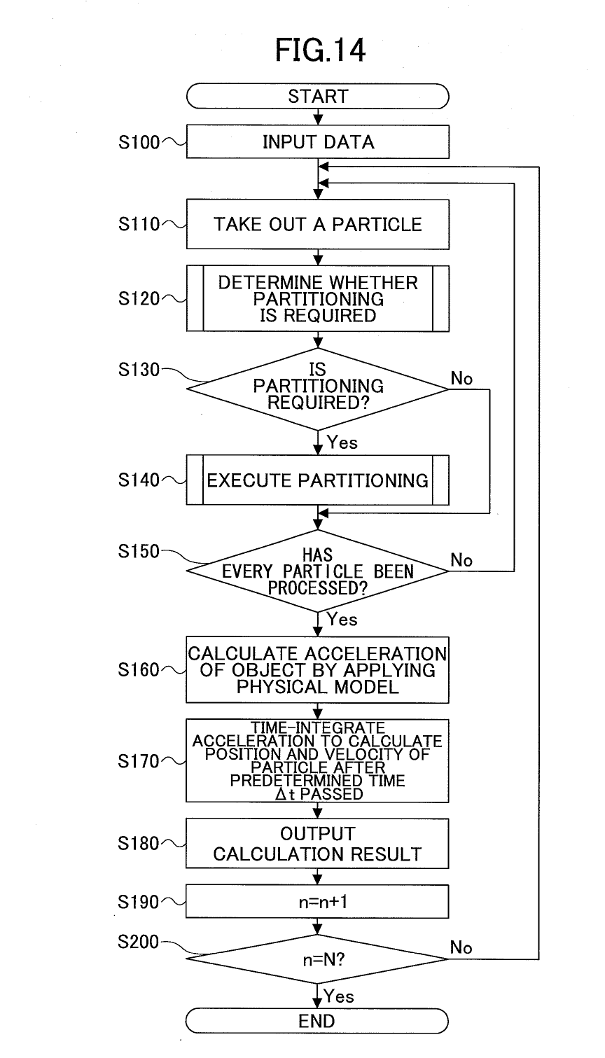

In the following, a process flow executed by the motion analysis apparatus 1 will be described with reference to a flowchart. FIG. 14 is the flowchart illustrating a flow of an overall process executed by the motion analysis apparatus 1.

First, the data input section 30 receives data of particles constituting an object as input, and stores the data into the memory unit 18 (Step S100). The input data includes an upper limit loop number N in addition to those described above. The upper limit loop number N is a value that specifies how many times a loop of Steps S110-S170 will be executed. The number of repetitions of the loop is counted as a processed loop count n on each execution of the loop. The processed loop count n has an initial value of 0.

The partitioning process section 32 takes out data of each particle stored in the memory unit 18 one by one, for example, in the stored order (Step S110), and determines whether a partitioning process is required (Step S120).

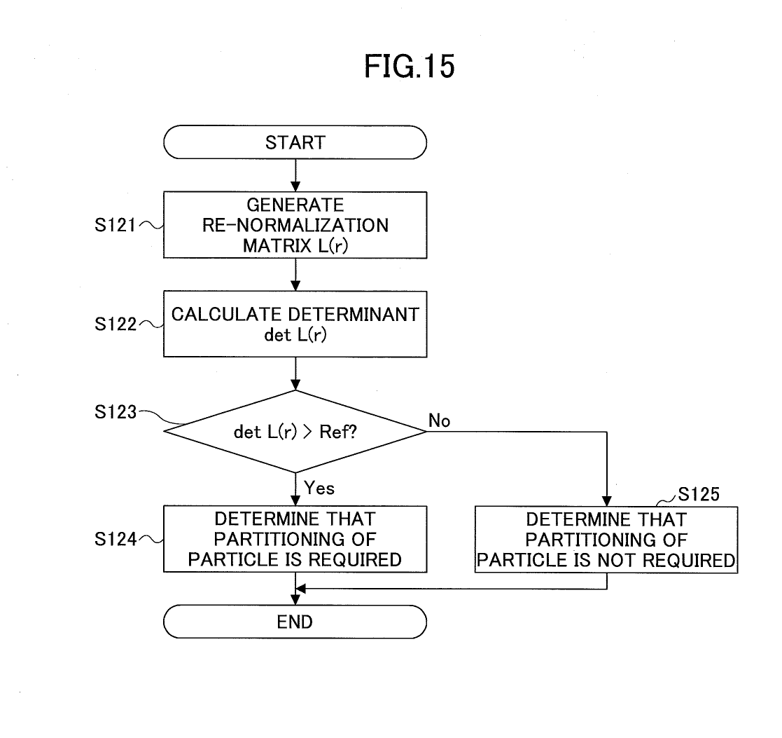

FIG. 15 is a flowchart illustrating a flow for determining whether a partitioning process is required. The partitioning process section 32 first generates a re-normalization matrix L(#r) (Step S121), and calculates the determinant det L(#r) (Step S122). Next, the partitioning process section 32 compares the determinant det L(#r) with the threshold value Ref to determine whether to partition the particle (Step S123). The partitioning process section 32 determines that partition of the particle is required (Step S124) if the determinant det L(#r) exceeds the threshold value Ref, or determines that partition of the particle is not required (Step S125) if the determinant det L(#r) is less than or equal to the threshold value Ref.

If determining that the partition is required at Steps S120-S125, the partitioning process section 32 partitions the particle and stores data of the positions, mass, and the like of the partitioned particles into the memory unit 18 (Steps S130-S140). On the other hand, if determining that the partition is not required at Steps S120-S125, the partitioning process section 32 does not execute a partitioning process (Step S130).

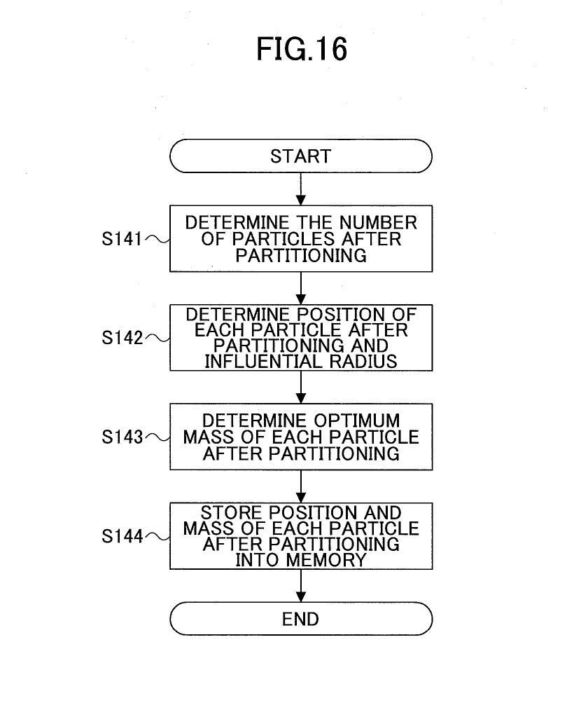

FIG. 16 is a flowchart illustrating a flow of a partitioning process. The partitioning process section 32 determines the number of particles that is to be obtained after partitioning based on distribution of other particles in the perimeter of the particle to be partitioned (Step S141). Next, the partitioning process section 32 determines the position and influential radius of partitioned particles (Step S142), and determines the optimum mass of each of the partitioned particles (Step S143). Then, the partitioning process section 32 stores data of the determined positions, mass, and the like of the partitioned particles into the memory unit 18 (Step S144).

Next, the partitioning process section 32 determines whether Steps S110-S144 have been executed for every particle to be analyzed (Step S150). If Steps S110-S144 have not been executed for every particle to be analyzed by the partitioning process section 32, the process goes back to Step S110. If Steps S110-S144 have been executed for every particle to be analyzed by the partitioning process section 32, the process goes forward to Step S160.

The motion analysis section 34 applies a physical model that corresponds to the type of an object to the data of the particles stored in the memory unit 18 to calculate acceleration of the particles (Step S160).

Then, the motion analysis section 34 calculates time integral of the acceleration to calculate the position and velocity of the particles after time Δt passes (Step S170), and outputs the calculated result to an external file if necessary (Step S180). Also, the motion analysis section 34 may display the calculated result of each routine on the display unit 24.

Next, the motion analysis section 34 increments the processed loop count n by one (Step S190), and determines whether the processed loop count n is equal to N (Step S200). If the processed loop count n is not equal to N, the process goes back to Step S110, or if the processed loop count n is equal to N, the process ends.

[Overview]

The motion analysis apparatus 1 according to the present embodiment can increase the number of particles by partitioning a particle even if a fluid or an elastic body is deformed significantly by shredding, shearing, and the like, and a part where particles are partially sparse appears with movement of the particles constituting the object. A “part where particles are partially sparse” is, as described earlier, a part where the number of other particles in the perimeter of a particle is less than a predetermined number, or a part where a predetermined uneven distribution relationship exist between the particle and the other particle.

As a result, the motion analysis apparatus 1 can maintain an environment where a sufficient number of the other particles exist in the perimeter of the particle, to accurately calculate forces (repulsive force and shearing force) that should operate on the particle. Therefore, the motion analysis apparatus 1 can analyze motion of an object more accurately.

Note that one would consider to place a lot of particles in the outset so that a sparse part of particle distribution does not appear when a fluid or an elastic body significantly deforms. In this case, however, an increased number of particles to be calculated may require excessive calculation load and calculation time. For example, if partitioning is performed on particles at the outset that would be partitioned into, for example, six new particles in, for example, the x axis direction, y axis direction, and z axis direction, respectively, as described above, distribution of particles becomes dense, which makes a partially sparse part less likely to appear. On the other hand, calculation of acceleration and the like for the particles increases six times greater, which makes the likelihood of inducing excessive calculation load and calculation time higher. Also, as it is often difficult to predict deformation of a fluid or an elastic body, a sparse part of particle distribution may appear even if particles are placed much more densely.

On the other hand, the motion analysis apparatus 1 according to the present embodiment performs partitioning only required parts, which reduces the total calculation load compared to the case where a lot of particles are placed at the outset. As a result, calculation speed can be improved. Further, as particles can be partitioned when necessary, it is possible to avoid sparse particle distribution even if a fluid or an elastic body continues to deform.

As described above, the motion analysis apparatus 1 according to the present embodiment can analyze motion of an object more accurately.

Further, the present invention is not limited to the specific embodiments described herein, and variations and modifications may be made without departing from the spirit and scope of the present invention.

For example, although it is described as an example in that the partitioning process section 32 determines whether to execute partition of a particle by comparing the determinant det L(#r) of a re-normalization matrix L(#r) with a threshold value Ref, the determination method of partitioning a particle is not limited to that. The partitioning process section 32 may determine to execute partitioning a particle by using vector calculation and the like for identifying a case where the number of other particles that exist within a predetermined range from a particle at the center is less than a predetermined number, or a case where the particle and the other particles exist on substantially the same plane or on substantially the same line.

### INDUSTRIAL USABILITY

The present invention can be used in the construction industry, manufacturing industry, computer software industry, and the like for analyzing motion of an object with a particle method. For example, by applying the present invention to fluid analysis of river water or sea water, it can be utilized for disaster prevention planning. Also, by applying the present invention to a casting process, it can be utilized for product design of a metal product and the like. Also, as an application of the present invention to an elastic body, it can be utilized for determining an appropriate form of a gel-like sealant when designing a product. Also, a program using the present invention can be on the market by itself.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A motion analysis apparatus comprising:
a storage section configured to store data representing a plurality of particles representing an object;
a partitioning process section configured to partition a particle of interest among the plurality of particles and to store data representing a plurality of partitioned particles obtained by partitioning the particle of interest into the storage section if a predetermined uneven distribution relationship exists between the particle of interest and other particles existing within a predetermined range having the particle of interest at a center of the predetermined range; and
a motion analysis section configured to analyze the motion of the object depending on a type of the object using the data representing the plurality of partitioned particles stored in the storage section.

2. The motion analysis apparatus as claimed in claim 1, wherein the predetermined uneven distribution relationship is a relationship where the number of the other particles existing within the predetermined range having the particle of interest at the center is less than a predetermined number.

3. The motion analysis apparatus as claimed in claim 1, wherein the predetermined uneven distribution relationship is a relationship where the particle of interest and the other particles exist on substantially the same plane or on substantially the same line.

4. The motion analysis apparatus as claimed in claim 1, wherein the partitioning process section stores the data representing the plurality of partitioned particles obtained by partitioning the particle of interest into the storage section if a value of a determinant of a re-normalization matrix having values of a function representing distribution of the particle of interest and the other particles as components is greater than or equal to a predetermined value.

5. The motion analysis apparatus as claimed in claim 4, wherein the re-normalization matrix is
$$L ( r ) = {( \begin{matrix}{\sum }_{b} ( {x}_{b} - x ) \frac{\partial }{\partial x} W ( \vert r - {r}_{b} \vert , h ) & {\sum }_{b} ( {x}_{b} - x ) \frac{\partial }{\partial y} W ( \vert r - {r}_{b} \vert , h ) & {\sum }_{b} ( {x}_{b} - x ) \frac{\partial }{\partial z} W ( \vert r - {r}_{b} \vert , h ) \\ {\sum }_{b} ( {y}_{b} - y ) \frac{\partial }{\partial x} W ( \vert r - {r}_{b} \vert , h ) & {\sum }_{b} ( {y}_{b} - y ) \frac{\partial }{\partial y} W ( \vert r - {r}_{b} \vert , h ) & {\sum }_{b} ( {y}_{b} - y ) \frac{\partial }{\partial z} W ( \vert r - {r}_{b} \vert , h ) \\ {\sum }_{b} ( {z}_{b} - z ) \frac{\partial }{\partial x} W ( \vert r - {r}_{b} \vert , h ) & {\sum }_{b} ( {z}_{b} - z ) \frac{\partial }{\partial y} W ( \vert r - {r}_{b} \vert , h ) & {\sum }_{b} ( {z}_{b} - z ) \frac{\partial }{\partial z} W ( \vert r - {r}_{b} \vert , h )\end{matrix} )}^{- 1}$$
where W represents a kernel function, h represents an influential radius of the particle of interest, r (vector representation) represents a position vector of the particle of interest, (x, y, z) represent vector components of the particle of interest, r_{b} (vector representation) represents a position vector of each of the other particles, and (x_{b}, y_{b}, z_{b}) represent vector components of each of the other particles.

6. The motion analysis apparatus as claimed in claim 1, wherein, if the predetermined uneven distribution relationship exists between the particle of interest and the other particles, the partitioning process section partitions the particle of interest in a direction perpendicular to a direction where the predetermined uneven distribution relationship exists between the particle of interest and the other particles.

7. The motion analysis apparatus as claimed in claim 1, wherein the partitioning process section determines positions of the plurality of partitioned particles, and then, determines mass of the plurality of partitioned particles so that a difference between density functions before and after the partitioning of the partitioned particles is small.

8. A motion analysis method for analyzing motion of a plurality of particles representing an object, the method being executed by a computer, the method comprising:
partitioning data representing a particle of interest among the plurality of particles into data representing a plurality of partitioned particles obtained by partitioning the particle of interest if a predetermined uneven distribution relationship exists between the particle of interest and other particles existing within a predetermined range having the particle of interest at a center of the predetermined range; and
analyzing the motion of the object depending on a type of the object, and using the data representing the plurality of partitioned particles.

9. A computer-readable recording medium having a program stored therein for causing a computer to execute a motion analysis method for analyzing motion of a plurality of particles representing an object, the method comprising:
partitioning data representing a particle of interest among the plurality of particles into data representing a plurality of partitioned particles obtained by partitioning the particle of interest if a predetermined uneven distribution relationship exists between the particle of interest and other particles existing within a predetermined range having the particle of interest at a center of the predetermined range; and
analyzing the motion of the object depending on a type of the object, and using the data representing the plurality of partitioned particles.
